(19) United States
(12) Patent Application Publication
(10) Pub. No.: US 2003/0033183 A1
(43) Pub. Date: Feb. 13, 2003

(54) Baby-sitter management method and program

(75) Inventors: Yukio Kawashima, Kawasaki (JP); Michihiro Miyasaka, Kawasaki (JP); Kiyoaki Doshida, Kawasaki (JP)

Correspondence Address: STAAS & HALSEY LLP, 700 11TH STREET, NW, SUITE 500, WASHINGTON, DC, 20001, US

(73) Assignee: Fujitsu Limited, Kawasaki (JP)

(21) Appl. No.: 10/094,853

(22) Filed: Mar. 12, 2002

(30) Foreign Application Priority Data
Aug. 13, 2001 (JP) 2001-245280

(51) Int. Cl. G06F 17/60

(52) U.S. Cl. 705/8

(57) ABSTRACT

A management method is for managing, in real time, the status of a baby-sitter dispatched based on a request from a user. When occurrence of abnormality is received from the dispatched baby-sitter, another baby-sitter is searched who is in the neighborhood of the baby-sitter from whom the occurrence of abnormality has been received, and the another baby-sitter is instructed on necessary measures to be taken. A program for managing baby-sitters allows a computer to execute an abnormality receive step which includes receiving occurrence of abnormality from a baby-sitter, and an abnormality-dealing step which includes searching another baby-sitter in the neighborhood of the baby-sitter who sent the occurrence of abnormality, and instructing the another baby-sitter to take necessary measures.

### BACKGROUND OF THE INVENTION

1. Field of the Invention

The present invention relates generally to a baby-sitter management method and a program for the same to manage, in real time, the status of baby-sitters dispatched by a baby-sitter mediation service, etc., and more particularly to a baby-sitter management method and a program for the same to provide appropriate services when any troubles have occurred.

2. Description of the Related Arts

Generally, to look for a baby-sitter, many users have to rely on an introduction by acquaintances, or before deciding whether or not to employ a baby-sitter from a certain agency, they themselves have to check up a telephone book to find out their nearest baby-sitter agencies, getting in touch with several of them and asking for pamphlets for making comparative study, further calling them for further detailed contents of services. But, nowadays, as some baby-sitter agencies set up advising sites on the Internet, the user can check up the outline of services and registration status of baby-sitters, or even can ask for pamphlets or ask questions by e-mail.

However, it takes some time for users to determine a baby-sitter-leasing company to meet the customer's requirement, and as to the entrusted baby-sitter-leasing company, there are many problems like disparity in understandings about the contents of services to be provided, between the customer and the baby-sitter-leasing company. Nowadays, the user can look at advertising sites of baby-sitter-leasing companies on the Internet, but the number of the currently set up sites is not enough to reach the user's nearest baby-sitter-leasing company, and the introduction of its services only offers one-sided information. Because of this, it is difficult for the user to get information for the purpose of judging the quality and the contents of services objectively. Consequently, the customer has to supplement his or her lack of information by referring to comments from the nearest family that entrusted a baby-sitter-leasing company in the past.

By the way, in the case of receiving a baby-sitter service using such a baby-sitter mediation system, the user has mainly two largest concerns: concern about how the baby-sitter would deal with problems, should illness or accident took place, and concern that the child would be left unattended by the baby-sitter, or the child would be treated cruelly. However, the present baby-sitter service almost fully dependent on the training and guidance given to baby-sitters by each baby-sitter-leasing company, and the actual status of the dispatched baby-sitter on site is not always grasped, giving rise to a problem that countermeasures cannot be taken sufficiently enough against sudden illness of the very baby-sitter, needless to say, sudden illness or injury of the child, as well. Also, even in rare cases, the child can be left unattended by the baby-sitter, or as a further extreme case, the child can be treated cruelly, and since they are put in a condition, as if in a secret room, and on top of that bad condition, the child to be cared is an infant, thereby making it harder to grasp what is going on actually at the site, causing a variety of anxieties of the customer always accompanied with the baby-sitter service, like “anxiety of own child being cared by others”, or “anxiety of allowing unknown person to join the family”, etc., and such many factors as described above lead up to the current state that the user cannot simply entrust the baby-sitter-leasing company, as to the service contents consisted of reliable relations among the customer, the baby-sitter-leasing company and the baby-sitter.

### SUMMARY OF THE INVENTION

According to the present invention there is provided a baby-sitter management method and a program for the same, quickly and properly dealing with abnormalities in real time, while the baby-sitter is on the site, to thereby give reliability and a feeling of security to customers.

The baby-sitter management method in accordance with a first aspect of the present invention comprises a management step which includes managing, in real time, the state of a baby-sitter dispatched in response to a request from a customer; an abnormality receive step which includes receiving occurrence of abnormality from a baby-sitter; and an abnormality-dealing step which includes searching another baby-sitter in the neighborhood of the baby-sitter who sent the occurrence of abnormality and instructing the another baby-sitter to take necessary measures. For this reason, even if any abnormality took place, like the dispatched baby-sitter could not move because of sudden illness, or an accident that cannot be treated by one baby-sitter, or illness or injury of the child took place, only by notice about abnormality taking place sent to a server at a management center, the server side can urgently make arrangements for another nearest baby-sitter to be dispatched.

Herein, the abnormality receive step of the baby-sitter management method includes receiving abnormality information and location information from a baby-sitter, and recognizing the contents of the abnormality and the place where the abnormality has occurred, and the abnormality-dealing step includes searching another baby-sitter located nearest to the place where the abnormality has occurred, and sending to the another baby-sitter a dispatch request which contains the place where the abnormality has occurred and the contents of the abnormality, and further sending to a customer the occurrence of the abnormality and the situation of measures which are being taken against the abnormality. The abnormality receive step includes judging that abnormality has occurred and shifting to the abnormality-dealing step, when regular contact from a baby-sitter stopped dead, when no response was received to the previously sent confirmation, or when there was abnormality in received information of a monitoring image. The abnormality receive step includes informing a fire department, a police station or other public organs thereon, if it is judged that there is a matter of urgency from the contents of abnormality information received from a baby-sitter. The abnormality receive step includes shifting to the abnormality-dealing step when receiving an abnormality occurrence notice from a customer based on an inquiry made by the customer to a baby-sitter being dispatched. Because of this, when calling the baby-sitter at home from the customers office, and the customer felt something strange in the situation of the baby-sitter at that time, as there would be possibilities of the baby-sitter leaving the child unattended, or treating the child cruelly, by notice about abnormality taking place sent from the customer to a management server, the server side recognizing notice about the abnormality taking place sent from the customer, can promptly take proper steps in real time, preventing the child from being cruelly treated or left unattended that may take place behind closed doors.

A second aspect of the present invention provides a program for managing baby-sitters, the program allowing a computer to execute an abnormality receive step which includes receiving occurrence of abnormality from a baby-sitter; and an abnormality-dealing step which includes searching another baby-sitter in the neighborhood of the baby-sitter who sent the occurrence of abnormality, and instructing the another baby-sitter to take necessary measures. Details of this program are substantially the same as the case of the baby-sitter management method.

The above and other objects, aspects, features and advantages of the present invention will become more apparent from the following detailed description when read in conjunction with the accompanying drawings.

### BRIEF DESCRIPTION OF THE DRAWINGS

FIGS. 1A and 1B are explanatory diagrams of a system configuration in accordance with the present invention;

FIGS. 2A and 2B are explanatory diagrams of customer information and baby-sitter information for use in the present invention;

FIGS. 3A and 3B are explanatory diagrams of position support information, monitor information, dispatch request information and notice information for use in the present invention;

FIGS. 4A and 4B are flowcharts showing the procedure of a baby-sitter management method in accordance with the present invention;

FIG. 5 is a flowchart of other baby-sitter search processing than those shown in FIGS. 4A and 4B;

FIG. 6 is a flowchart of other baby-sitter dispatch request sending process than those shown in FIGS. 4A and 4B;

FIG. 7 is a flowchart of abnormality occurrence notice destination searching processing of FIGS. 4A and 4B; and

FIG. 8 is a flowchart of abnormality occurrence notice sending processing of FIGS. 4A and 4B.

### DETAILED DESCRIPTION OF THE PREFERRED EMBODIMENT

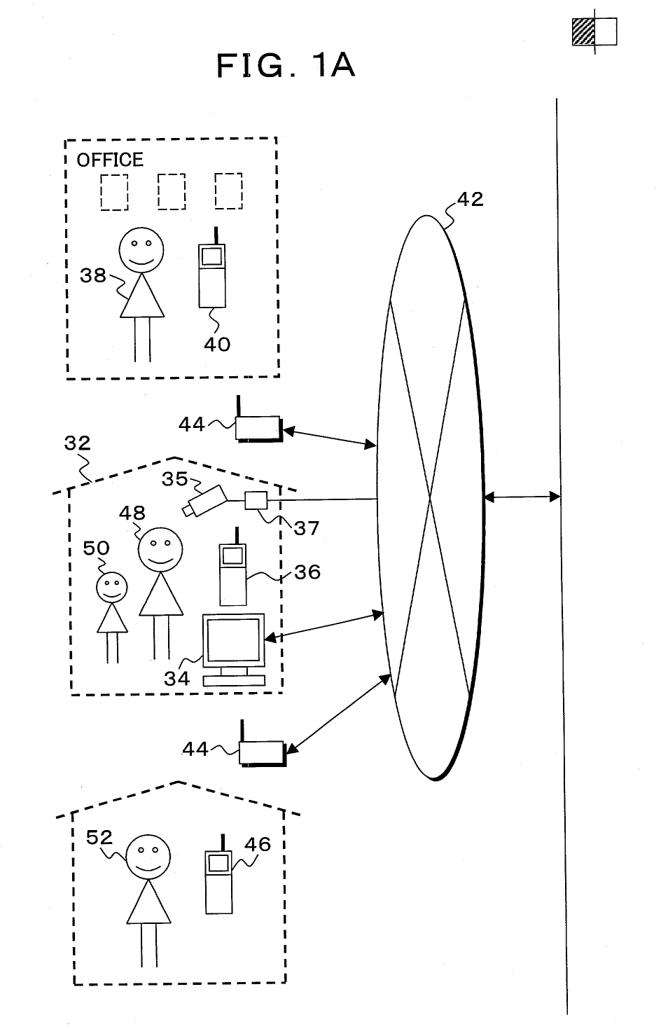

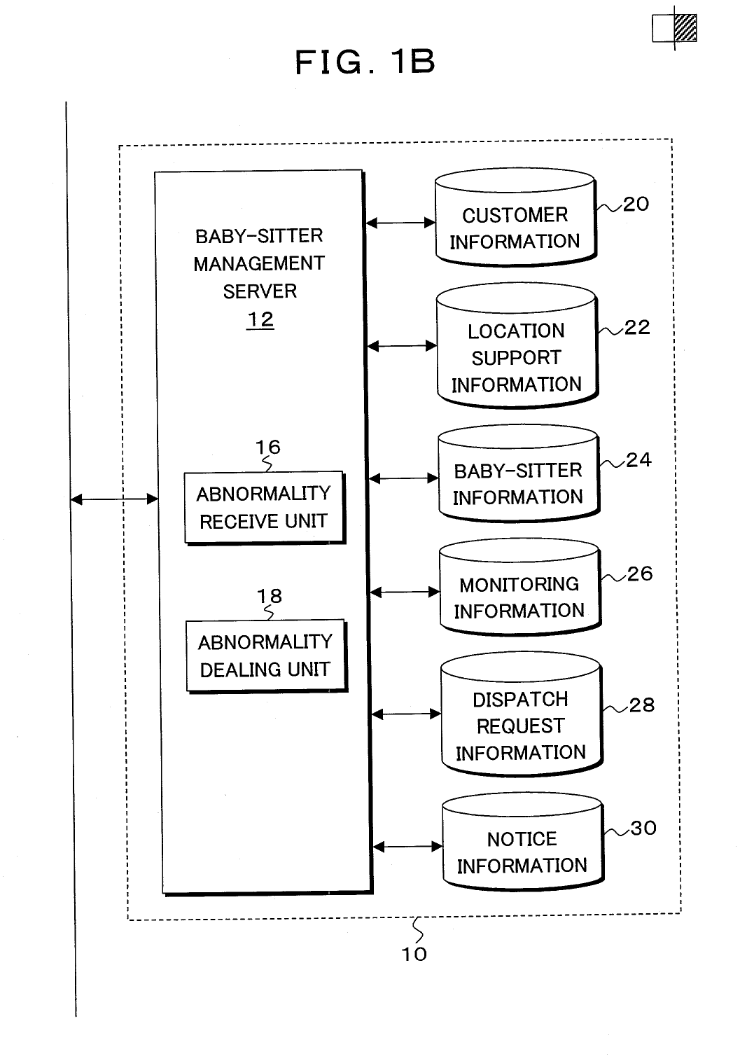

FIGS. 1A and 1B are explanatory diagrams of a baby-sitter service mediation system to which is applied a baby-sitter management method in accordance with the present invention. A baby-sitter service mediation system 10 includes a baby-sitter management server 12. To the baby-sitter management server 12, an abnormality receive unit 16 and an abnormality-dealing unit 18 are installed. Also, as information to execute management processing by the baby-sitter management server 12, customer information 20, location support information 22, baby-sitter information 24, monitor information 26, dispatch request information 28 and notice information 30 are installed, and of these pieces of information, dispatch request information 28 and notice information 30 are temporary files. The baby-sitter mediation system having the baby-sitter management server 12 as described above, registers information on a plurality of baby-sitter-leasing companies, and each subscriber (user) can select a dispatcher who meets the desired conditions from a plurality of baby-sitter-leasing companies, by taking a glimpse at the web page of the server, and accept the baby-sitter service, based on the contract signed up with the selected baby-sitter-leasing company, thus, as to the state of the baby-sitter dispatched to the subscriber (user) from the baby-sitter dispatcher, a real time management can be made by the baby-sitter management server 12. In order to manage the baby-sitter by the baby-sitter management server 12, a baby-sitter 48 dispatched to a subscriber's home 32 holds a mobile terminal 36, like PDA or a mobile phone, so that information can be communicated with the baby-sitter management server 12, through a radio station 44 and a network 42, by a radio communication from the mobile terminal 36. Also, at the subscriber's home, a terminal device 34, like a personal computer, is installed, and using this terminal device 34, the subscriber can apply for dispatching a baby-sitter to the baby-sitter mediation system 10, or can obtain necessary information, or further can sign a contract on line. Moreover, at the subscriber's home 32, where the baby-sitter 48 is to be dispatched, a TV camera 35 for monitoring purpose is installed with an approval obtained from a subscriber 38 who asked for dispatch, so that on the side of the baby-sitter management server 12, the monitoring video image of the subscriber's home 32 can be received from the private terminal device 37 through the network 42. Further, the subscriber 38, who put his or her child 50 under the care of the baby-sitter 48, is, for instance, in his or her office, and the subscriber 38 holds a mobile terminal 40, so that information can be communicated or telephone calls can be made between the baby-sitter management server 12 of the baby-sitter service mediation system 10 and the mobile terminal 36 of the baby-sitter 48 dispatched to the subscriber's home 32.

Further FIGS. 1A and 1B express a baby-sitter 52 in a neighborhood of the baby-sitter 48 dispatched to the subscriber's home 32, for supporting her, if any emergency should occur to her, and the baby-sitter 52 also holds a mobile terminal 46 for communicating information with the baby-sitter management server 12. The abnormality receive unit 16 installed to the baby-sitter management server 12 receives an abnormality occurrence from the baby-sitter 48 dispatched to the subscriber's home 32. For instance, when the baby-sitter 48 dispatched to the subscriber's home 32 became unworkable because of sudden illness, the baby-sitter 48 is to notify the baby-sitter management server 12 about the abnormality occurrence, using own mobile terminal 36 held by her. As this notice of abnormality occurrence is so programmed that abnormality notice information is pre-registered, for instance, in the mobile terminal 36, and when a pre-determined key number is entered, the abnormality occurrence is informed to the baby-sitter management server 12, therefore, for instance, abnormality occurrence information and location information are to be sent to the baby-sitter management server 12. Because of this system, on the baby-sitter management server 12, the abnormality receive unit 16 receives abnormality information and location information on the occurrence of abnormality from the baby-sitter 48, and recognizes the contents of the abnormality and the location where abnormality taking place, by deciphering the received contents. When the abnormality receive unit 16 receives the occurrence of abnormality from the baby-sitter 48, the abnormality-dealing unit 18 searches another baby-sitter, for instance, a baby-sitter 52, in a place nearest to the place where the abnormality taking place, for instance, the subscriber's home 32, based on abnormality information and location information obtained from the received abnormality occurrence, and sends dispatch request information including the location where the abnormality taking place and the abnormality contents to a mobile terminal 46 of the searched baby-sitter 52. Upon receiving information, the baby-sitter 52 promptly visits the subscriber's home 32, where abnormality occurred, so as to attend on the baby-sitter 48 who cannot work because of sudden illness, or to take her to a hospital, etc., as well as to make necessary cares for the child 50. Wherein, the receipt of abnormality occurrence by the abnormality receive unit 16 can be considered to include, for instance, a failure when the unit failed to receive a regular notice to be sent from the baby-sitter 48 at specified time intervals, in addition to the receipt of abnormality occurrence information from the baby-sitter 48. Also, such a case can be judged as occurrence of abnormality, when in response to confirmation information that is sent from the baby-sitter management server 12 to the baby-sitter 48 periodically, the unit failed to receive response information from the baby-sitter 48 to this confirmation information. Moreover, since on the side of the baby-sitter management server 12 can receive monitoring video image sent from the TV camera 35 installed at the subscriber's home 35, even such a case when an abnormality is found by an operator checking the received monitoring video image, or by image processing, can be similarly judged as receiving abnormality occurrence, and dealing processing can be made by the abnormality dealing unit 18. Further, the present invention enables the subscriber 38 itself, who receives the service of the baby-sitter 48, to judge abnormality. To be more specific, when signing up a contract on the baby-sitter service mediation system, the subscriber 38, who receives service of the baby-sitter 48, contracted on liaison matters to check the state of the child with the baby-sitter 48, calling the subscriber's home 32 by the mobile terminal 40, while the baby-sitter is being dispatched. By agreement being reached to periodically make an inquiry about the state by the subscriber 38 to the dispatched baby-sitter 48, the subscriber 38 can know the state of the child, getting in touch with the baby-sitter 48 being dispatched. Making an inquiry by the subscriber 38 to the baby-sitter 48 is performed for the purpose of getting known of cruel treatment of the child 50, or leaving the child 50 unattended by the baby-sitter 48, at an early stage, so that proper steps can be taken. In short, when the subscriber 38 gets in touch with the baby-sitter 48 being dispatched, making an inquiry about the state of the child 50, if the subscriber feels something strange, or feels the baby won't stop crying, or has feelings of anxiety, the subscriber 38 is to send a pre-determined abnormality code to the baby-sitter management server 12, using the subscriber's own mobile terminal 40. When the abnormality receive unit 16 of the baby-sitter management server 12 receives abnormality occurrence based on the inquiry made from the subscriber 38 to the baby-sitter 48 being dispatched, like the receipt of abnormality occurrence from the baby-sitter 48, by the abnormality dealing unit 18, for instance, an emergency dispatch request is made to a baby-sitter 52 who is in the nearest place to the baby-sitter 48, so that countermeasures against abuse of the child by the baby-sitter 48, like leaving the child unattended or cruelly treating the child, can be taken at an early stage. Moreover, when recognizing any abnormality, like a theft, fire, etc., from information on abnormality occurrence received by the abnormality receive unit 16, the abnormality dealing unit 18 of the baby-sitter management server 12 will report to a police at dial 110, with a condition that the operator on the system side confirmed a theft, or will report to a fire office at dial 119, waiting for the confirmation made by the operator on the server side. By this system, the server side can take proper steps against emergency occurred, like theft, fire, etc., that cannot be dealt with by the baby-sitter.

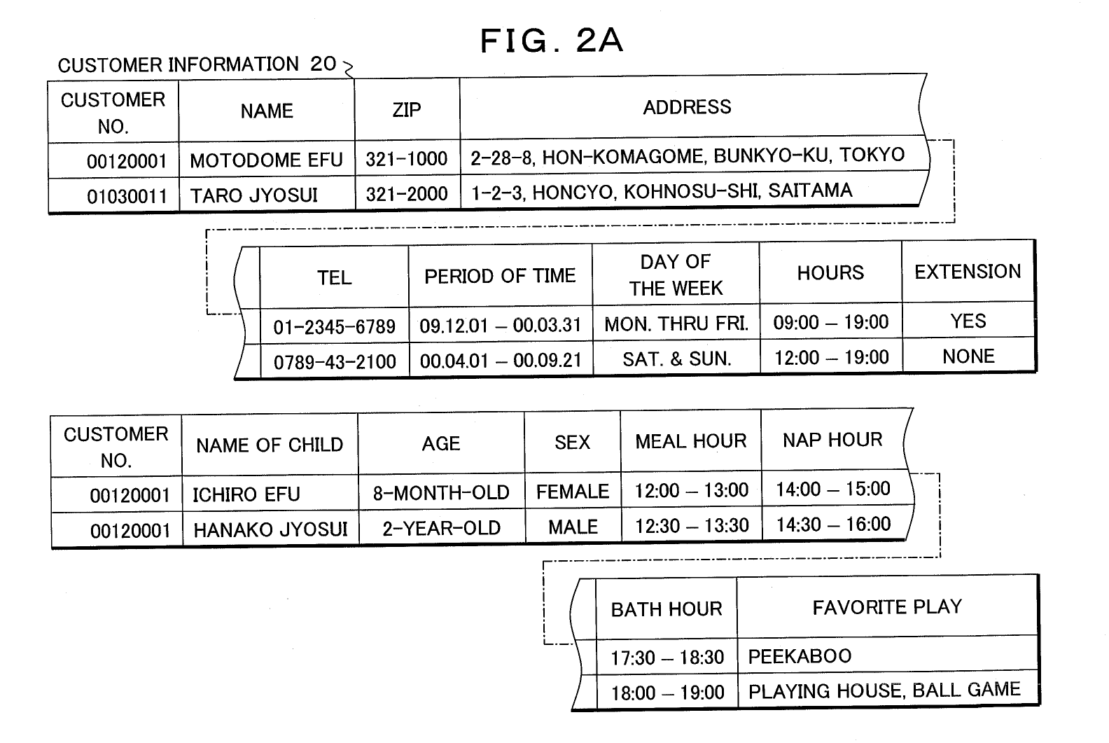

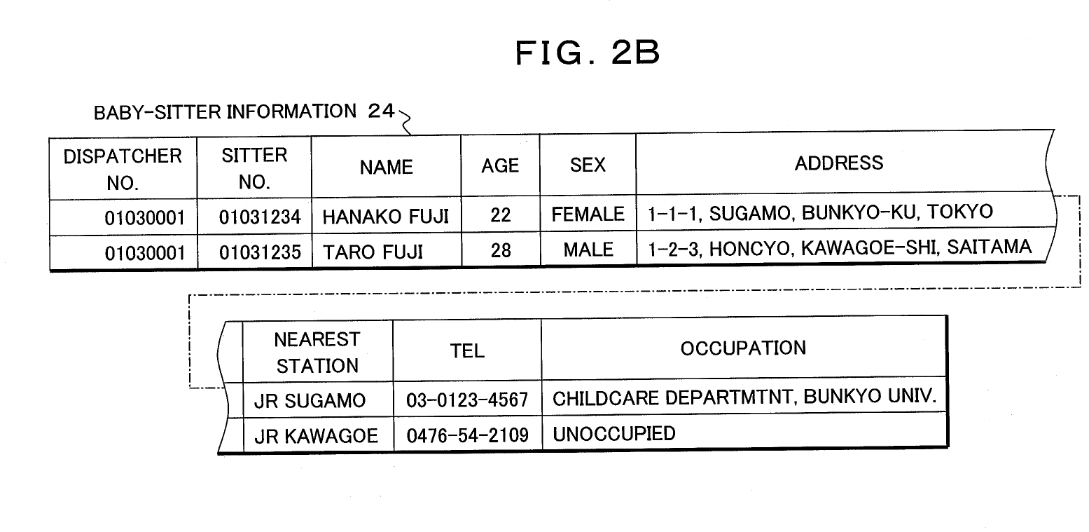

FIGS. 2A and 2B show specific examples of the registered contents of customer information 20 and baby-sitter information 24 installed to the baby-sitter management server 12 shown in FIGS. 1A and 1B. Customer information 20 in FIG. 2A is information concerning each subscriber who receives baby-sitter services, and registers individual customer No., name, ZIP code, address, telephone No., followed by information concerning a baby-sitter dispatching period, a day of the week, a time period, and whether the period is extended or not. For instance, the subscriber 38 shown in FIGS. 1A and 1B, has the customer No. “0012001”, and receives services from Monday through Friday of the time period from 9 through 19 o'clock. Also, to customer information 20, information of a child at a baby-sitter dispatching destination is linked, and information of the child includes the customer No., name of the child, age and sex, followed by a time period of taking meal, a time period of taking a nap, and a time period of taking a bath, and further includes information of favorite play of the child, etc. In the case as shown in FIGS. 1A and 1B, it can be understood that the children 50 at the subscriber having the customer No. 38, to which the baby-sitter 48 is dispatched, are a 8 months old boy and a 2 years old girl.

FIG. 2B shows a specific example of baby-sitter information 24 shown in FIGS. 1A and 1B. In baby-sitter information 24, the dispatcher No. who dispatches a baby-sitter, sitter No., age, sex, address, nearest station, telephone No., occupation, etc. comprising the ID of the baby-sitter itself, are registered. The baby-sitter 48 dispatched to the subscriber's home 32 shown in FIGS. 1A and 1B has, for instance, sitter number “01031234”. Also, the baby-sitter 52 being in the neighborhood and to be dispatched for occurrence of abnormality of the baby-sitter 48 shown in FIGS. 1A and 1B is to be a baby-sitter having a sitter number “01031235”.

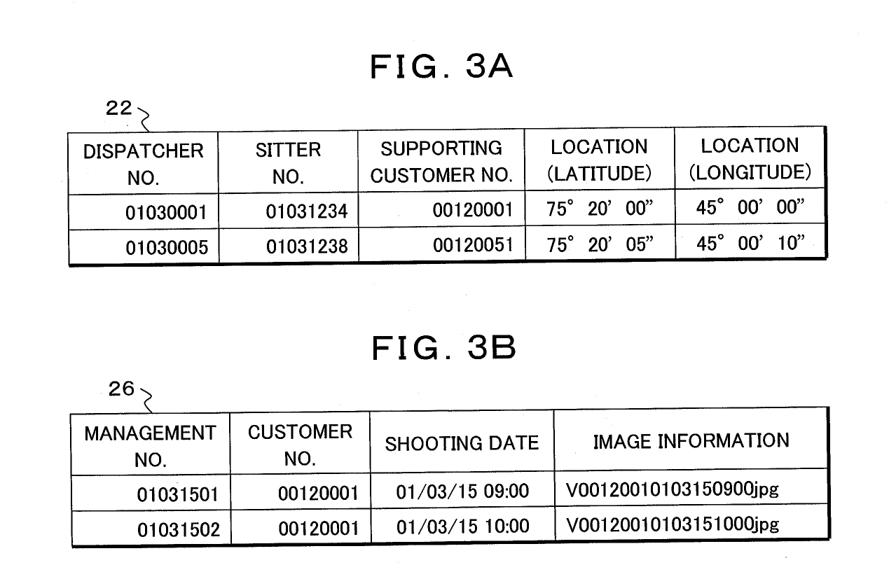

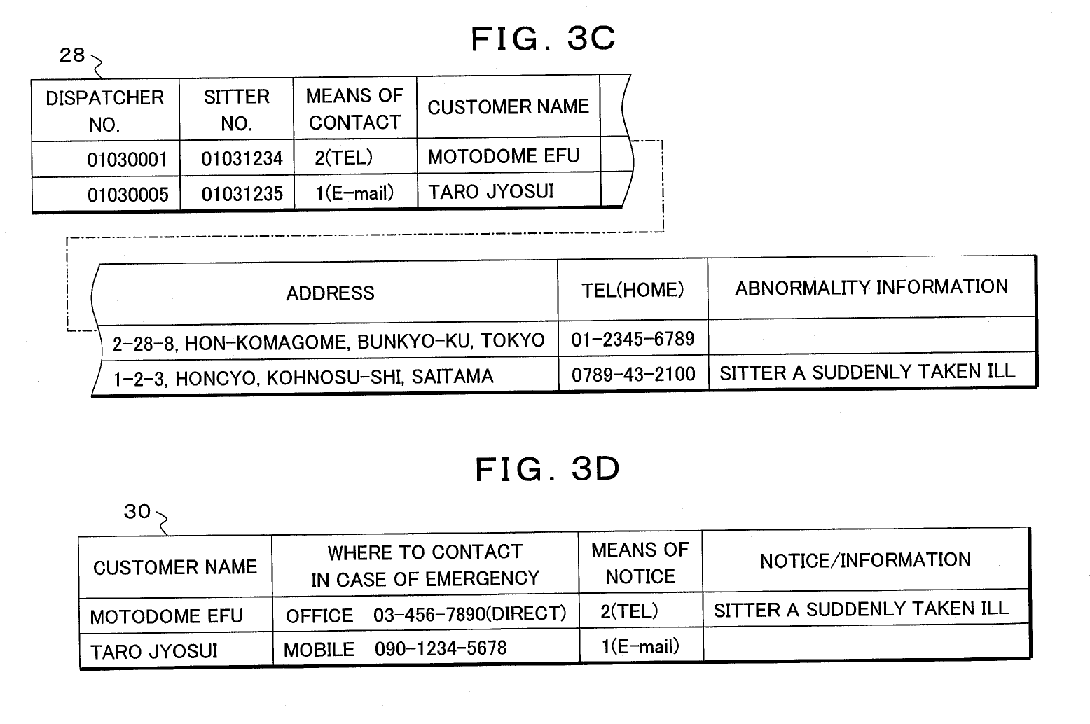

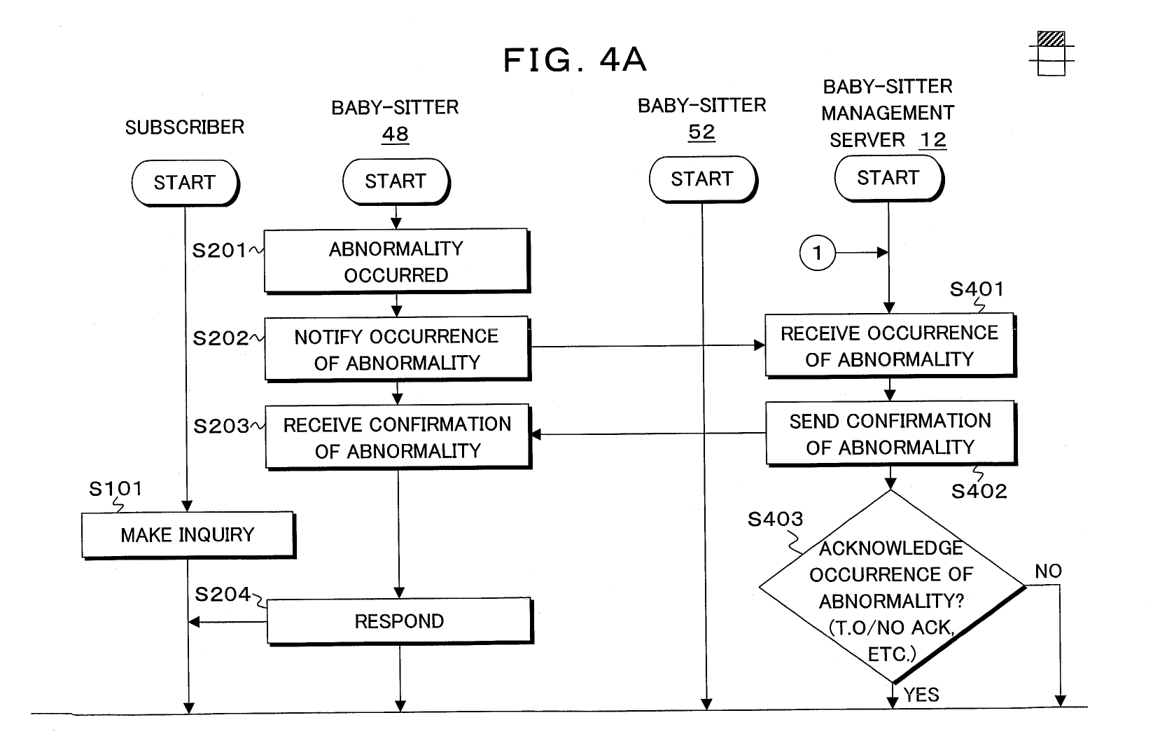

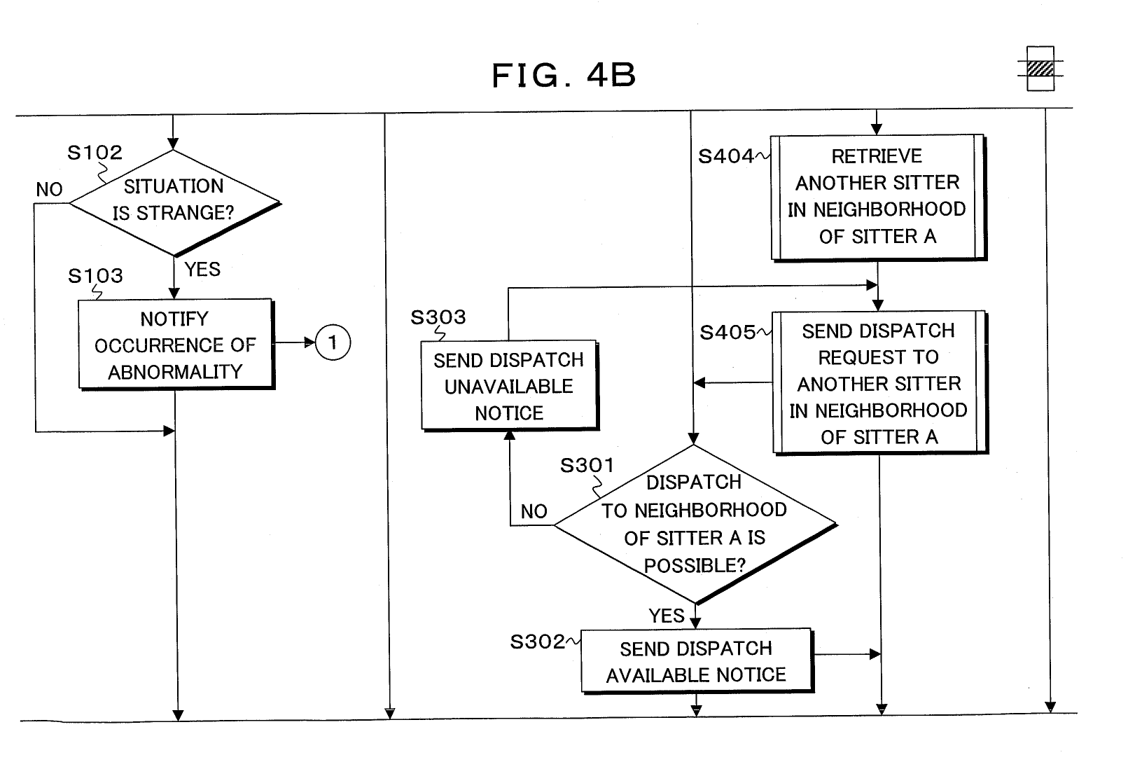

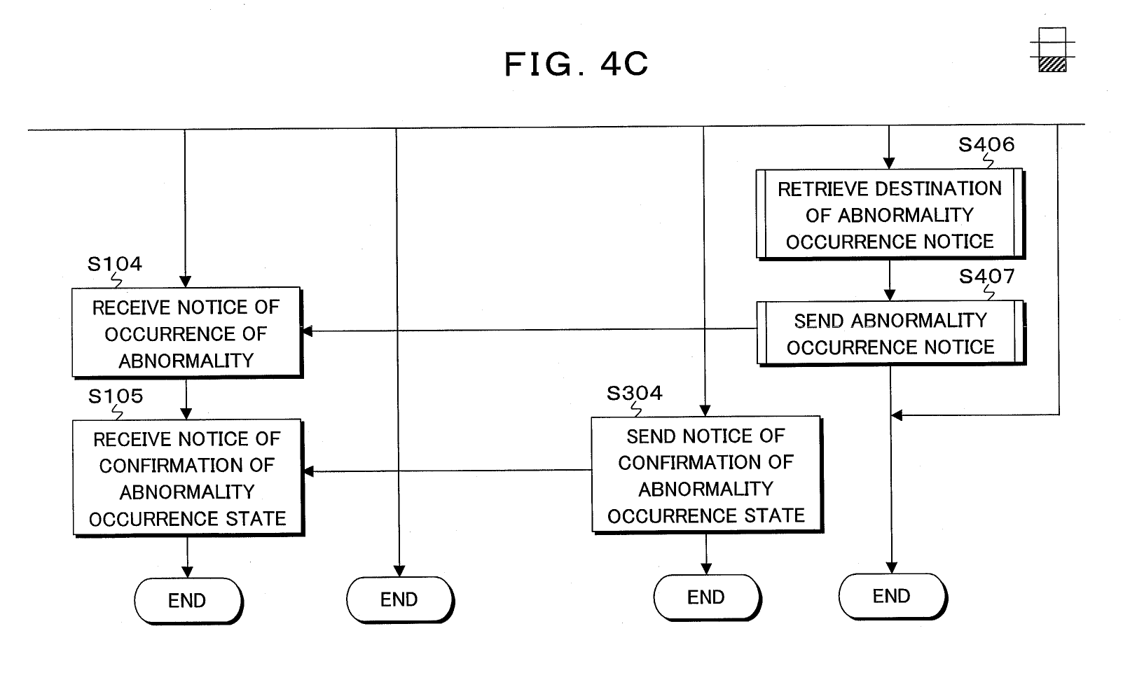

FIGS. 3A through 3D are explanatory diagrams of the specific registered contents of location support information 22, monitor information 26, dispatch request information 28 and notice information 30 that are installed to the baby-sitter management server 12 shown in FIGS. 1A and 1B. Location support information 22 shown in FIG. 4A registers information concerning the current location of the baby-sitter currently dispatched to a subscriber's home. For instance, it can be understood that the baby-sitter 48 having a sitter number “01031234” dispatched to the subscriber's home 32 is dispatched to the location to be pinpointed by longitude and latitude. The values of longitude and latitude representing information of the current location of the baby-sitter can be known in real time, by means of, for instance, allowing the baby-sitter to bring a GPS transmitter, and the baby-sitter management server 12 to receive information from this transmitter. FIG. 3B shows the monitoring video image shot by a TV camera installed at a subscriber's home where a baby-sitter is dispatched, and the video image registers the subscriber No., customer No., followed by the date of shooting, and further followed by image information actually shot. Image information is updated, for instance, once every 10 minutes, but, if any abnormality is received, updating cycles can be shortened, so that further detailed image information can be received. Dispatch request information 28 shown in FIG. 3C is a temporary file to be created temporary when the abnormality receive unit 16 of the baby-sitter management server 12 receives, for instance, abnormality occurrence from a baby-sitter. Dispatch request information 28 registers dispatcher No., sitter No., followed by as means of making contact, for instance, telephone or e-mail, and further information stores customer name who is now receiving service, followed by customer name as the dispatching destination, dispatching destination address, dispatching destination telephone No. and further abnormality information causing a dispatch request. In this case, since a dispatch request is made to the baby-sitter 52 having a sitter No. “1031235”, in accordance with abnormality occurrence caused by sudden illness of the baby-sitter having a sitter No. “01031234”, who is in unworkable state, as abnormality information, “sitter A suddenly taken ill” will be registered. FIG. 3D shows notice information 30 for informing the subscribed customer as to occurrence of abnormality, and the information is also registered as a temporary file regarding occurrence of abnormality. Notice information 30 will register each customer name, where to make contact in case of an emergency, and informing means, followed by “sitter A suddenly taken ill” as information to be notified.

FIGS. 4A and 4B are flowcharts showing processing procedure of baby-sitter management processing by the baby-sitter management server 12 shown in FIGS. 1A and 1B, together with exchange of communications among the subscriber 38, the baby-sitter 48 being dispatched, and the baby-sitter 52 receiving a dispatch request in accordance with occurrence of abnormality. Now, it is assumed that the baby-sitter 48 is dispatched to the subscriber's home 32 to take care for the child 50, requested by the subscriber 38. And, also it is assumed that under this condition, the baby-sitter 48 becomes unworkable because of sudden illness, and abnormality occurred at the step S201. Against this abnormality, the baby-sitter 48 informs the baby-sitter management server 12 about abnormality occurred, using own mobile terminal 36. Notice informing of abnormality occurred sent from the baby-sitter 48 is received at a step S401 of the baby-sitter management server 12, and at a next step S402, confirmation of the abnormality is sent to the baby-sitter 48, and upon receipt of the confirmation, at a step S203, on the mobile terminal 36 of the baby-sitter 48, received information of the abnormality confirmation is displayed. By this display, the baby-sitter 48 who becomes unworkable due to sudden illness can know that notice of abnormality to the baby-sitter management server has been confirmed, so the baby-sitter can wait until another baby-sitter comes, feeling at rest. The baby-sitter management server 12, that received occurrence of abnormality at the step S401, and sent confirmation of abnormality at the step S402, recognizes occurrence of abnormality at a step S403. The server recognizes occurrence of abnormality because there are two pieces of received information, abnormality information and location information. After recognizing the occurrence of abnormality, at a step S404, the server performs search processing of another baby-sitter in the neighborhood of the baby-sitter 48. As to searching of another baby-sitter to whom dispatch request is made, searching is performed for a plurality of baby-sitter candidates. Next, at a step S405, a dispatch request is sent to another baby-sitter 52 in the neighborhood of the baby-sitter 48, as the baby-sitter 52 is topping the candidate list. Upon receiving this dispatch request, the baby-sitter 52 checks whether it is possible to work instead of the baby-sitter 48 or not, at a step S301, and if possible, at a step S302, sends a O.K. notice to the baby-sitter management server 12. On the other hand, if the baby-sitter 52 cannot accept the dispatch request for some reasons, at a step S303, the baby-sitter sends a canceling notice to the baby-sitter management server 12, and upon receiving this canceling notice, at a step S405, the baby-sitter management server 12 sends a dispatch request to another baby-sitter who is a second candidate already searched, and thus, the server has to continuously send dispatch requests to candidates on the list, from topping to the bottom sequentially, until a dispatch requested is accepted. As described above, when the baby-sitter management server 12 finishes sending a dispatch request to another baby-sitter in the neighborhood, at a step S406, the server searches the destination of informing about occurrence of abnormality. To be more specific, the server searches the informing destination to inform the subscriber requesting dispatch of the baby-sitter 48 that abnormality occurred to the baby-sitter 48. When the informing destination is successfully searched at a step S406, the server sends a notice of abnormality occurrence to the subscriber, at a step S407, and as to the reaction, the subscriber, at a step S104, receives notice of occurrence of abnormality, and can recognize that an urgent situation took place to the baby-sitter 48 dispatched to the subscriber's home, and also necessary steps have been taken by a dispatch request sent to a baby-sitter in the neighborhood. The baby-sitter 52 who receives a dispatch request, after sending an O.K. notice at the step S302, at a step S304, makes notice of confirming abnormality occurred state to the subscriber, and the subscriber receives it at a step S105, so, the subscriber can confirm the necessary steps against the occurrence of abnormality have been taken by receiving notice of confirmed the abnormality occurred state sent from the baby-sitter 52. While, the subscriber makes an inquiry to the baby-sitter 48 dispatched to the subscriber's home using a mobile terminal, at a step S101. To this inquiry, the dispatched baby-sitter 48 responses to the inquiry from the subscriber, at step S204. Through such inquiries made by the subscriber to the baby-sitter 48, if the subscriber should feel that the situation of the baby-sitter 48 is strange, the subscriber judges whether the situation being normal or abnormal, at a step S102, then at a step S103, informs about occurrence of abnormality to the baby-sitter management server 12. This notice of occurrence of abnormality from the subscriber is received at the step S401 of the baby-sitter management server 12, but, in this case, processing at the step S402 for sending abnormality confirmation will not be performed, and after passing through the step S403, processing goes on to the step S404 for searching another baby-sitter nearby, then to the step S405 for sending a dispatch request to another baby-sitter in the neighborhood, and processing further goes on to the following steps, in the same manner as in the case of abnormality occurrence notice from the baby-sitter 48, and eventually, another baby-sitter in the neighborhood can be dispatched to the place of the baby-sitter 48 as informed by the subscriber, so the newly dispatched baby-sitter can properly deal with the situation which the subscriber felt unusual.

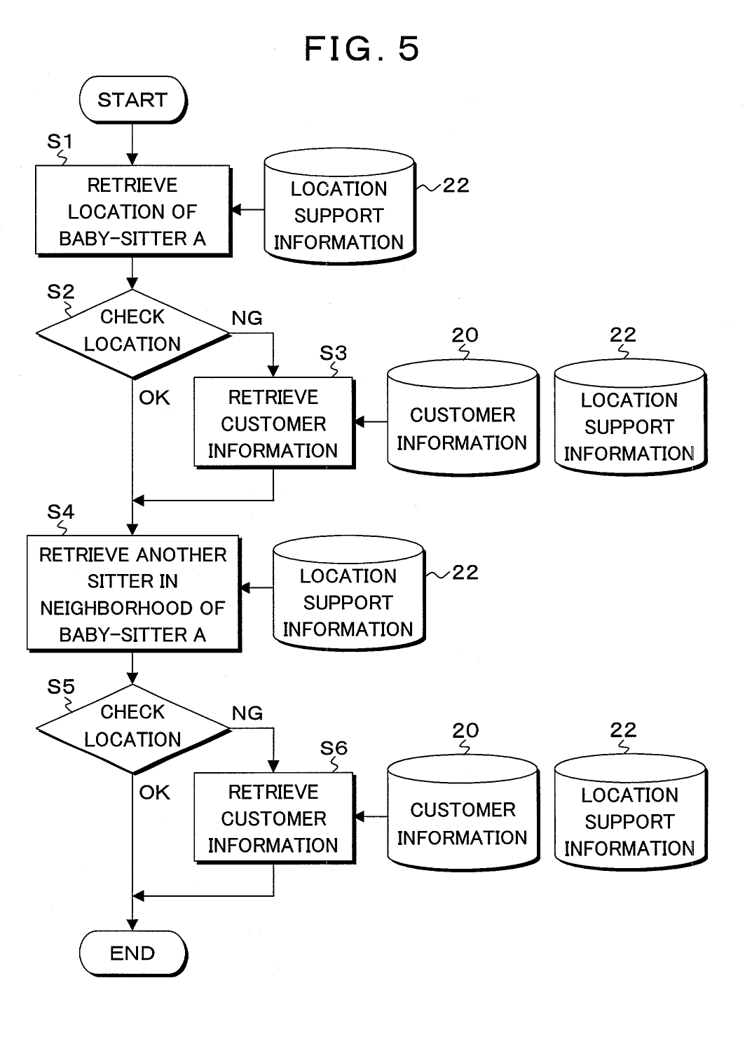

FIG. 5 is a flowchart showing detailed search processing of another baby-sitter in the neighborhood against occurrence of abnormality at the step S404 of the baby-sitter management server 12 shown in FIGS. 4A and 4B. In search processing of another baby-sitter, the location of the baby-sitter 48 is searched at a step S1. To search the location of the baby-sitter 48, since the sitter No. of the baby-sitter 48 can be obtained from the received notice about abnormality occurrence, location information in terms of latitude and longitude indicating the position of a sitter A can be known with location support information shown in FIG. 3A referred to by the sitter No. Next, at a step S2, whether the position can be confirmed or not by the result of location search of the baby-sitter 48 is checked, and if the position of the baby-sitter 48 could not be confirmed, processing goes on to a step S3, and searching of customer information is performed. As customer information 20 contains addresses as shown in FIG. 2A, the location of the baby-sitter 48 can be known from this. When at the step S2, the location of the baby-sitter 48 can be searched from location support information 22, or when the location of the baby-sitter 48 can be searched from searching of customer information at the step S3, processing goes on to a step S4 to search the location of another baby-sitter in the neighborhood of the baby-sitter 48 from location support information 22. In short, against location information in terms of latitude and longitude of the baby-sitter 48 with sitter No. “01031234” shown in FIG. 3A, for instance, another baby-sitter 52 with sitter No. “01031235”, is searched, as another baby-sitter having location information of nearest latitude and longitude. As to searching of another baby-sitter 52, when another baby-sitter in the neighborhood cannot be searched from location support information 22 at a step S5, at a step S6, another baby-sitter is searched using of location support information 22, under the support by customer information 20.

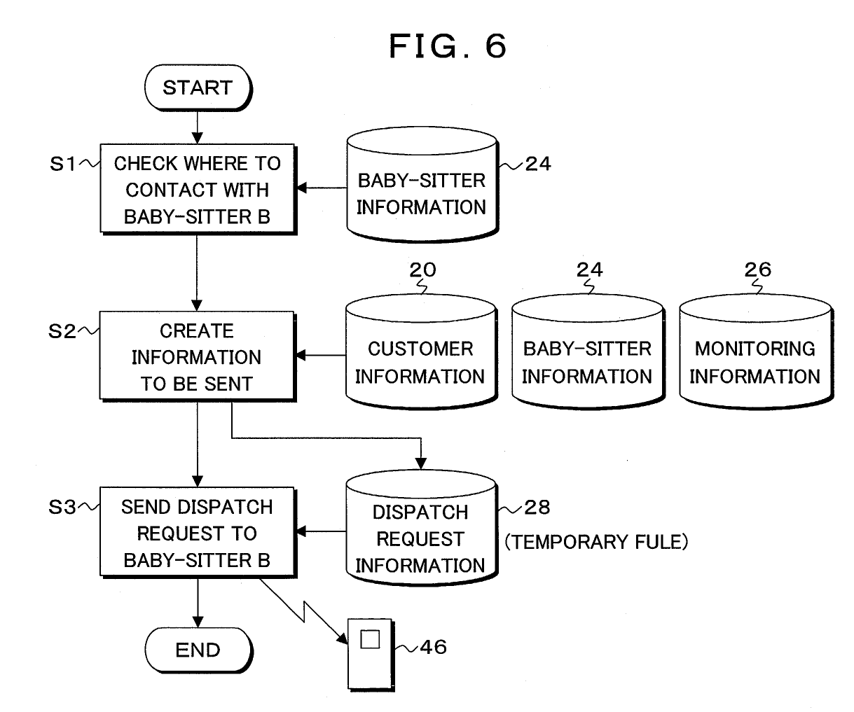

FIG. 6 shows a flowchart of processing of sending another nearby baby-sitter dispatch request g at the step S405 shown in FIGS. 4A and 4B. This process of sending another baby-sitter dispatch request confirms where to make contact with another baby-sitter already searched at the step S1, referring to baby-sitter information 24 shown in FIG. 2B. In other words, as to the baby-sitter 52, for instance, the telephone No. of the baby-sitter is confirmed, by searching of baby-sitter information 24 by the sitter No. “01031235”. Then, at the step S2, information to be sent is created for dispatch request. This creation of sending information for requesting dispatch is made with reference to customer information 20, baby-sitter information 24 and monitoring information 26, and created information is temporarily kept in dispatch request information 28. Next at the step S3, a dispatch request is sent to the baby-sitter 52, so that the baby-sitter 52 can recognize the dispatch request, receiving the request, for instance, by the mobile terminal 46.

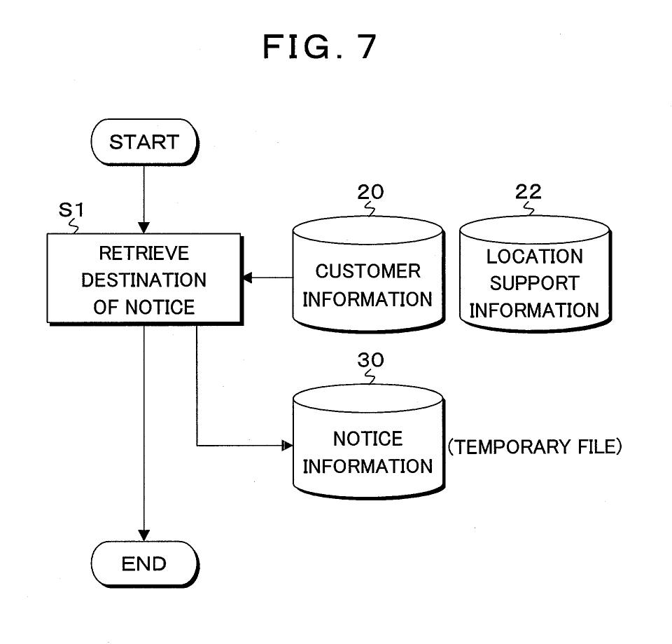

FIG. 7 is a flowchart of the searching process of abnormality occurrence informing destination at the step S406 shown in FIGS. 4A and 4B. This searching of abnormality occurrence informing destination refers to customer information 20 and location support information 22 at the step S1, to search the subscriber who is currently receiving services of the baby-sitter 48 and to whom abnormality occurrence is to be informed, and together with the search, notice information 30 is created as a temporary file.

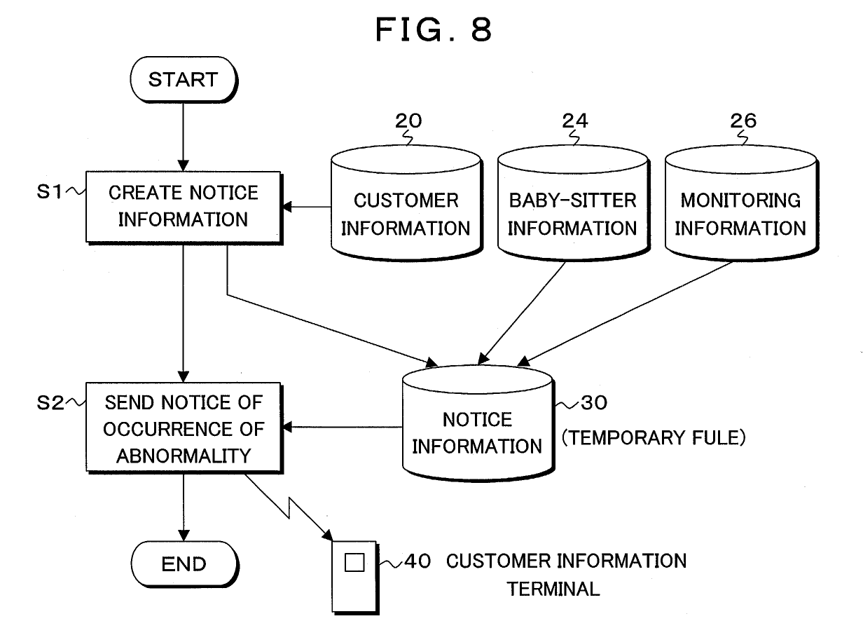

FIG. 8 is a flowchart of the sending process of abnormality occurrence notice at the step S407 shown in FIGS. 4A and 4B. This sending process of abnormality occurrence notice refers to customer information 20, baby-sitter information 24 and monitoring information 26 at the step S1, and creates notice information 30 as a temporary file. Further at the step S2, the process reads out notice information 30 to the subscriber who is searched out as the informing destination shown in FIG. 8, and sends notice about abnormality occurrence to the mobile terminal 40 of the subscriber.

Further, the present invention is to provide a program itself to embody the baby-sitter management method, and to be more specific, the program is provided as a program to embody the flowchart of the baby-sitter management server 12 shown in FIGS. 4A and 4B, and the flowchart in the subroutine of the steps S404, S405, S406 and S407 shown in FIG. 5 through FIG. 8.

As described above, according to the present invention, even if the dispatched baby-sitter became unworkable because of sudden illness, or even if any accident occurred that could not be handled by oneself, like illness or injury of the child, by means of informing the management server of occurrence of abnormality, the server side can recognize the occurrence of abnormality, making a dispatch request to another baby-sitter in the nearest place to the baby-sitter who informed of abnormality and urgently dispatching alternative baby-sitter, thus, proper and prompt steps can be taken against occurrence of abnormal state.

Further, if the subscriber felt something unusual, when making an inquiry to the baby-sitter being dispatched, by means of informing the management server side of occurrence of abnormality, a dispatch request is made to another nearby baby-sitter, so that prompt and proper steps can be taken, in the same manner as described in the above case, therefore, as to worries held by the subscriber who requested services of a baby-sitter, like if the child could left unattended or cruelly treated by the baby-sitter can be promptly and properly eliminated in real time so that the child can be protected from being left unattended or being treated cruelly by the baby-sitter.

By the way, the embodiment described above takes the case where the subscriber and the baby-sitter mutually exchange information or communication with the baby-sitter management server, using mobile terminals, but it is a matter of course that, in addition to the mobile terminal, other appropriate communication device or terminal device having a communication function can be used. And, a GPS is taken here as location information, but, other appropriate detection system of location information can naturally be used. Also, the present invention includes appropriate variants without impairing the object and the advantage of the present invention.

What is claimed is:

1. A baby-sitter management method comprising:
a management step which includes managing, in real time, the state of a baby-sitter dispatched in response to a request from a customer;
an abnormality receive step which includes receiving occurrence of abnormality from a baby-sitter; and
an abnormality-dealing step which includes searching another baby-sitter in the neighborhood of said baby-sitter who sent the occurrence of abnormality and instructing said another baby-sitter to take necessary measures.

2. The method according to claim 1, wherein
said abnormality receive step includes receiving abnormality information and location information from a baby-sitter, and recognizing the contents of the abnormality and the place where the abnormality has occurred, and wherein
said abnormality-dealing step includes searching another baby-sitter located nearest to the place where the abnormality has occurred, and sending to said another baby-sitter a dispatch request which contains the place where the abnormality has occurred and the contents of the abnormality, and further sending to a customer the occurrence of the abnormality and the situation of measures which are being taken against said abnormality.

3. The method according to claim 2, wherein
said abnormality receive step includes judging that abnormality has occurred and shifting to said abnormality-dealing step, when regular contact from a baby-sitter stopped dead, when no response was received to the previously sent confirmation, or when there was abnormality in received information of a monitoring image.

4. The method according to claim 2, wherein
said abnormality receive step includes informing a fire department, a police station or other public organs thereon, if it is judged that there is a matter of urgency from the contents of abnormality information received from a baby-sitter.

5. The method according to claim 1, wherein
said abnormality receive step includes shifting to said abnormality-dealing step when receiving an abnormality occurrence notice from a customer based on an inquiry made by said customer to a baby-sitter being dispatched.

6. A program for managing baby-sitters, the program allowing a computer to execute:
an abnormality receive step which includes receiving occurrence of abnormality from a baby-sitter; and
an abnormality-dealing step which includes searching another baby-sitter in the neighborhood of said baby-sitter who sent the occurrence of abnormality, and instructing said another baby-sitter to take necessary measures.

7. The program according to claim 6, wherein
said abnormality receive step includes receiving abnormality information and location information from a baby-sitter, and recognizing the contents of the abnormality and the place where the abnormality has occurred, and wherein
said abnormality-dealing step includes searching another baby-sitter located nearest to the place where the abnormality has occurred, and sending to said another baby-sitter a dispatch request which contains the place where the abnormality has occurred and the contents of the abnormality, and further sending to a customer the
